(19) United States
(12) Patent Application Publication
(10) Pub. No.: US 2017/0324900 A1
(43) Pub. Date: Nov. 9, 2017

(54) INSTRUCTION INPUT APPARATUS WITH PANORAMIC PHOTOGRAPHY FUNCTION

(71) Applicant: HEROIC POWER CO., LTD., Shenzhen City (CN)

(72) Inventor: Yao-Chung LIN, Taipei (TW)

(21) Appl. No.: 15/589,121

(22) Filed: May 8, 2017

(30) Foreign Application Priority Data
May 9, 2016 (CN) 201610300154.1

(51) Int. Cl. H04N 5/232; H04N 5/225; H04N 7/04; G06F 3/02

(52) U.S. Cl. CPC H04N 5/23238; H04N 7/04; G06F 3/0202; H04N 5/2253; H04N 5/23296

(57) ABSTRACT

An instruction input apparatus is provided. The instruction input apparatus comprises a keyboard, on which a plurality of buttons are disposed; a camera module, which comprises a supporting bar and a camera, wherein a first end of the supporting bar is connected to the keyboard, the camera is disposed on a second end of the supporting bar so as to protrude the camera from the keyboard, and the camera comprises at least two lens modules for capturing a plurality of image frames; and an image processing unit, which is disposed in the keyboard and is signal-connected to the camera so that the image processing unit receives and processes the image frames for merging the image frames into a panorama image. Therefore, the instruction input apparatus would improve the functionality of the instruction input apparatus and provide function of all viewing angles photographing so that the instruction input apparatus has an advantage of taking all desired images together.

### FIELD OF THE INVENTION

The present invention relates to an instruction input apparatus. More particularly, the present invention relates to an instruction input apparatus with panoramic photography function.

### BACKGROUND OF THE INVENTION

Along with a greatly increased capacity of communication network, a video conference is widely adapted. However, carrying and disposing the hardware equipment needed in a video conference, including image projecting apparatuses, computer hosts, cameras and microphones, is difficult and time consuming because the hardware equipment exists in different cases separated from each other. Therefore, the equipment used in a video conference is usually fixed in a meeting room and cannot be moved easily.

A novel multifunctional keyboard, details of which can be found in Chinese utility model patent No. CN205103768U, is developed to overcome the issue mentioned above. Functionality of the keyboard is greatly increased because the keyboard simultaneously has functions of many external devices by disposing assembly grooves on a bottom surface of a main shell and on a pallet for assembling small-size speaker, noise-reduction microphone and camera. Although the direction of camera photographing can be freely changed by assembling the camera onto a flexible metal tube, it is hard to provide a thorough image containing all necessities by the keyboard being usually disposed at center of the meeting room because the viewing angle of the camera is limited. It is one of the objects of the present invention to solve the drawbacks described above.

### SUMMARY OF THE INVENTION

One of the objects of the present invention is to provide an instruction input apparatus, specifically relating to an instruction input apparatus which generates panorama images and can be easily carried.

In order to achieve the objects described above, one embodiment of the present invention provides an instruction input apparatus comprising: a keyboard, on which a plurality of buttons are disposed; a camera module, which comprises a supporting bar and a camera, wherein a first end of the supporting bar is connected to the keyboard, the camera is disposed on a second end of the supporting bar so as to protrude the camera from the keyboard, and the camera comprises at least two lens modules for capturing a plurality of image frames; and an image processing unit, which is disposed in the keyboard and is signal-connected to the camera so that the image processing unit receives and processes the image frames for merging the image frames into a panorama image.

According to above, the instruction input apparatus in one embodiment of the present invention further comprises a network unit being signal-connected to the image processing unit, wherein the network unit completes signal connection with a network, and transmits the panorama image to a remote host connected with the network once in a certain period.

According to above, the instruction input apparatus in one embodiment of the present invention further comprises a sound capturing unit being signal-connected to the image processing unit, wherein the sound capturing unit captures sounds in outside environment, generates a sound signal accordingly and transmits the sound signal to the image processing unit, and the image processing unit integrates a video signal transmitted from the remote host and a content input from the keyboard to generate a multimedia file.

According to above, the instruction input apparatus in one embodiment of the present invention further comprises an image projecting module being signal-connected to the image processing unit for displaying the multimedia file generated from the image processing unit.

According to above, the camera module in the instruction input apparatus in one embodiment of the present invention is vibration proof and rotates to photograph an area of which a viewing angle is between a first range at a first time point and photograph an area of which a viewing angle is between a second range at a second time point, so as to capture the image frames.

Another object of the present invention is to provide an instruction input apparatus, which comprises: a keyboard, on which a plurality of buttons are disposed; a camera module, which comprises a supporting bar and a camera, wherein a first end of the supporting bar is connected to the keyboard, the camera is disposed on a second end of the supporting bar, and the camera rotates to face a first area of which a viewing angle is between a first range and to face a second area of which the viewing angle is between a second range such that a plurality of image frames are captured; and an image processing unit, which is disposed in the keyboard and is signal-connected to the camera so that the image processing unit receives and processes the image frames for merging the image frames into a panorama image.

According to above, the instruction input apparatus in one embodiment of the present invention further comprises a network unit being signal-connected to the image processing unit, wherein the network unit completes signal connection with a network, and transmits the panorama image to a remote host connected with the network once in a certain period.

According to above, the instruction input apparatus in one embodiment of the present invention further comprises a sound capturing unit being signal-connected to the image processing unit, wherein the sound capturing unit captures sounds in outside environment, generates a sound signal accordingly and transmits the sound signal to the image processing unit, and the image processing unit integrates a video signal transmitted from the remote host and a content input from the keyboard to generate a multimedia file.

According to above, the instruction input apparatus in one embodiment of the present invention further comprises an image projecting module being signal-connected to the image processing unit for displaying the multimedia file generated from the image processing unit.

According to above, the instruction input apparatus in one embodiment of the present invention further comprises a vibration detector disposed in the keyboard for generating a vibration signal in response to vibration of the keyboard, transmitting the vibration signal to the image processing unit, the image projecting module or the camera, such that the image projecting module generates a vibration-proof projecting image.

Therefore, the instruction input apparatus provided by the embodiments of the present invention would improve the functionality of the instruction input apparatus and provide function of all viewing angles photographing so that the instruction input apparatus has an advantage of taking all desired images together.

### BRIEF DESCRIPTION OF THE DRAWINGS

FIG. 1 is a functional module diagram showing an instruction input apparatus with built-in all viewing angles photographing function according to one embodiment of the present invention.

FIG. 2 is an illustration diagram of appearance of the camera module 12 according to one embodiment of the present invention.

FIG. 3 is an illustration diagram of appearance of the camera module according to another embodiment of the present invention.

### DETAILED DESCRIPTION OF PREFERRED EMBODIMENTS

Details of the embodiments which could realize the features and advantages of the present invention are described in the following descriptions. It should be known that variations in different embodiments of the present invention could be performed and are within the scope of the technical solutions of the present invention. The descriptions and drawings herein are used for descripting but not for limiting the present invention.

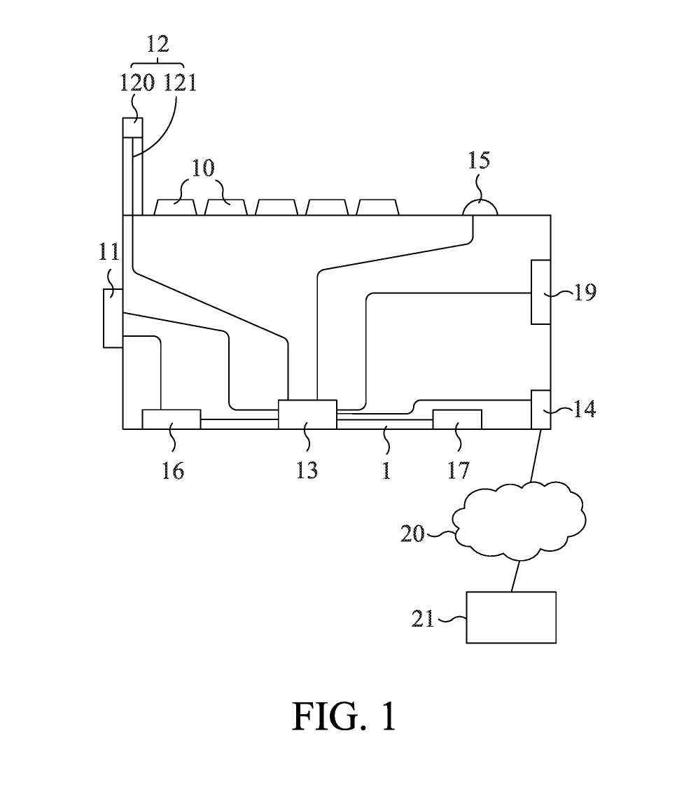

Please refer to FIG. 1, which is a functional module diagram showing an instruction input apparatus with built-in all viewing angles photographing function according to one embodiment of the present invention. In this embodiment, the instruction input apparatus comprises a keyboard 1 which can be signal-connected to a controlled apparatus, such as signal-connected to a smartphone or a tablet through Bluetooth or wireless network. A plurality of buttons 10 are disposed on the keyboard 1, and a battery set 17, which could either be a rechargeable battery or a non-rechargeable battery, is disposed in the keyboard 1 for providing electricity required for operation. An image projecting module 11 is also disposed in the keyboard 1 and for receiving an image signal, converting the image signal into a projecting image frame and projecting the image frame onto a projection surface (not shown in the figure). The projection surface could be screens, surfaces of desk, walls, floor or any object on which the image frame can be projected. The source of the image signal can be image signals inputted from a computer host (not shown in the figure) or an optical-disk displayer (not shown in the figure) in outside environment via the video input terminal 19. Or, the source can be the image signals generated by an android stick, a TV stick or a computer stick externally connected to a connecting slot. Besides, in the embodiment of the present invention, in order to reduce the occurrence of instability of the projected image due to knocking the buttons 10 on the keyboard 1, a vibration detector 16 is further disposed in the keyboard 1 for generating a vibration signal in response to vibrations generated on the keyboard 1 and transmitting the vibration signal to the image projecting module 11 and the image processing unit 13 to perform compensation operation and generate a vibration-proof projecting image accordingly. Details of the related technique can be found in the contents of another Chinese patent application No. CN 201610262290.6. It is noted that the term “signal-connected” means that signal can be transmitted between the two elements being signal-connected with each other via wire or wireless transmission way.

The camera module 12 is disposed on the keyboard 1 and the camera 120 of the camera module 12 is protruded from and above the keyboard 1. The image processing unit 13 is disposed in the keyboard 1 and signal-connected to the camera 120 for processing the image frames captured by the camera 120. Besides, a network unit 14 and a sound capturing unit 15 are disposed in the keyboard 1 of the input instruction apparatus and are signal-connected to the image processing unit 13, respectively. In order to stabilize the camera 120 while capturing images, the camera module 12 could be vibration-proof so that a dynamic compensation is performed in accordance with the vibration signal generated by the vibration detector 16.

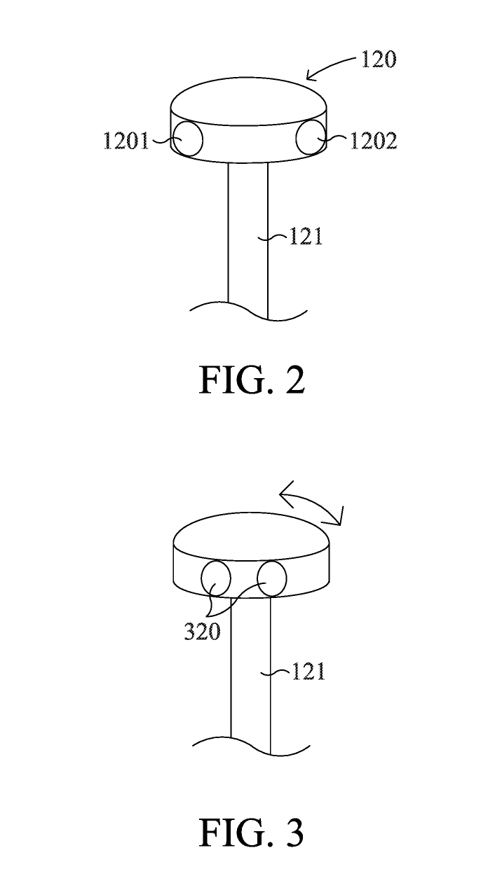

Please refer to FIG. 2, which is an illustration diagram of appearance of the camera module 12 according to one embodiment of the present invention. The camera module 12 in the present embodiment primarily comprises a supporting bar 121 and the camera 120. One end of the supporting bar 121 is connected to the keyboard 1, and the camera 120 is disposed on another end of the supporting bar 121 so as to protrude the camera 120 from and be above the keyboard 1. The camera 120 primarily comprises two or more lens modules. Taking the first lens module 1201 and the second lens module 1202 shown in FIG. 2 as an example, each of the lens module captures an image frame of which the viewing angle is at least 180 degree. It is noted that the viewing angle of the captured image frame of each lens module could be decreased when an amount of the lens modules is increased. The image frames captured by the module lens are transmitted to the image processing unit 13 such that the image processing unit 13 processes the image frames to merge the image frames into a panorama image. Then, the panorama image can be used in a conference meeting after being processed. The mechanism of the supporting bar 121 could be various, however, details of which are not described herein since it can be accomplished by many public solutions.

In one embodiment, after the network unit 14 in FIG. 1 completes signal connection with the network 20, a panorama image is transmitted to the remote host 21 from the network unit 14 once in a certain period at the time point when the panorama image is generated. The panorama image is then displayed on a display apparatus related to the remote host 21. It is noted that the sound signals captured by the sound capturing unit 15 and any contents, such as words, position information of the cursor, etc., inputted by the instruction input apparatus can be integrated with the panorama image through the image processing unit 13 to form a panorama multimedia file. The panorama multimedia file is transmitted to the remote host 21 through the network unit 14 and then used by the remote host 21. The image projecting module 11 in the embodiment of the present invention can be used for displaying the panorama image, or the image projecting module 11 displays the multimedia file generated from integrating a video signal transmitted from the remote host 21 and a content input from the keyboard 1 by the image processing unit 13. Besides the conference meeting, the present invention could be applied to eSports games in personal computers or smart phones to transmit the panorama image captured by the instruction input apparatus of the present invention to players other than the user in the eSports games. In one embodiment of the present invention, a speaker can be installed in the keyboard 1 to play dialogues in the conference meeting or the sound signals in the corresponded multimedia file.

Please refer to FIG. 3, which is an illustration diagram of appearance of the camera module according to another embodiment of the present invention. In the embodiment, the camera module 320 can rotate forwards and backwards along the direction of arrows so that the camera on the camera module 320 faces a first area of which a viewing angle is between a first range and faces a second area of which the viewing angle is between a second range, so that a plurality of image frames can be captured by the camera module 320. In this way, although the camera module 320 cannot cover all viewing angles, a first image frame corresponding to the area having its viewing angle between the first range can be captured by the camera module 320 at a first time point, a second image frame corresponding to the area having its viewing angle between the second range can be captured by the camera module 320 at a second time point, and the captured image frames, such as the first image frame and the second image frame, are transmitted to the image processing unit 13 in FIG. 1 for merging them together to form the panorama image. After that, the panorama image can be used in the conference meeting after being processed.

The apparatus and methods described above can solve the issues of photographing images with limited viewing angles in the traditional technique. For the keyboards being usually disposed at center of a meeting room, all desired images can be captured and therefore the drawbacks are solved. Accordingly, the primary object of the present invention is achieved, and the present invention is suitable for being used in those minimized mobile electronic apparatus.

Those described above are embodiments of the present invention and are not for limiting the present invention. While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An instruction input apparatus, comprising:
a keyboard, on which a plurality of buttons are disposed;
a camera module, which comprises a supporting bar and a camera, wherein a first end of the supporting bar is connected to the keyboard, the camera is disposed on a second end of the supporting bar so as to protrude the camera from the keyboard, and the camera comprises at least two lens modules for capturing a plurality of image frames; and
an image processing unit, which is disposed in the keyboard and is signal-connected to the camera so that the image processing unit receives and processes the image frames for merging the image frames into a panorama image.

2. The instruction input apparatus according to claim 1, further comprising a network unit being signal-connected to the image processing unit, wherein the network unit completes signal connection with a network, and transmits the panorama image to a remote host connected with the network once in a certain period.

3. The instruction input apparatus according to claim 2, further comprising a sound capturing unit being signal-connected to the image processing unit, wherein the sound capturing unit captures sounds in outside environment, generates a sound signal accordingly and transmits the sound signal to the image processing unit, and the image processing unit integrates a video signal transmitted from the remote host and a content input from the keyboard to generate a multimedia file.

4. The instruction input apparatus according to claim 3, further comprising an image projecting module being signal-connected to the image processing unit for displaying the multimedia file generated from the image processing unit.

5. The instruction input apparatus according to claim 1, wherein the camera module is vibration proof and rotates to photograph an area of which a viewing angle is between a first range at a first time point and photograph an area of which a viewing angle is between a second range at a second time point, so as to capture the image frames.

6. An instruction input apparatus, comprising:
a keyboard, on which a plurality of buttons are disposed;
a camera module, which comprises a supporting bar and a camera, wherein a first end of the supporting bar is connected to the keyboard, the camera is disposed on a second end of the supporting bar, and the camera rotates to face a first area of which a viewing angle is between a first range and to face a second area of which the viewing angle is between a second range such that a plurality of image frames are captured; and
an image processing unit, which is disposed in the keyboard and is signal-connected to the camera so that the image processing unit receives and processes the image frames for merging the image frames into a panorama image.

7. The instruction input apparatus according to claim 6, further comprising a network unit being signal-connected to the image processing unit, wherein the network unit completes signal connection with a network, and transmits the panorama image to a remote host connected with the network once in a certain period.

8. The instruction input apparatus according to claim 7, further comprising a sound capturing unit being signal-connected to the image processing unit, wherein the sound capturing unit captures sounds in outside environment, generates a sound signal accordingly and transmits the sound signal to the image processing unit, and the image processing unit integrates a video signal transmitted from the remote host and a content input from the keyboard to generate a multimedia file.

9. The instruction input apparatus according to claim 8, further comprising an image projecting module being signal-connected to the image processing unit for displaying the multimedia file generated from the image processing unit.

10. The instruction input apparatus according to claim 9, further comprising a vibration detector disposed in the keyboard for generating a vibration signal in response to vibration of the keyboard, transmitting the vibration signal to the image processing unit, the image projecting module or the camera, such that the image projecting module generates a vibration-proof projecting image.
